(19) United States
(12) Patent Application Publication
(10) Pub. No.: US 2021/0102517 A1
(43) Pub. Date: Apr. 8, 2021

(54) ELECTRIC PUMP ASSISTED FUEL SYSTEM

(71) Applicant: Hamilton Sundstrand Corporation, Charlotte, NC (US)

(72) Inventors: Ryan Susca, Windsor, CT (US); Charles E. Reuter, Granby, CT (US); Naison E. Mastrocola, Goshen, CT (US); Jesse C. Peters, Windsor, CT (US); Gary L. Miles, Stillman Valley, IL (US); Robert A. Bayles, Belvidere, IL (US); Adrian L. Stoicescu, Roscoe, IL (US)

(21) Appl. No.: 16/593,746

(22) Filed: Oct. 4, 2019

(51) Int. Cl. F02M 37/00; F02C 9/26; F02C 7/232; B60K 15/03

(52) U.S. Cl. CPC F02M 37/0047; F02C 9/26; F02M 37/0017; F02C 7/232; F05D 2220/323; B60K 2015/0319; B60K 2015/03243; B60K 2015/03256; B60K 15/03

(57) ABSTRACT

A fuel system for an engine including a first flow line, an electrically driven startup pump in fluid communication with the first flow line to provide a startup flow, a main flow line, a main pump in fluid communication with the main flow line to provide a main flow, and a switching valve connected to the first flow line and the main flow line, the switching valve configured to select between the first flow line and the main flow line to output either the startup flow or the main flow.

### BACKGROUND

### Technological Field

This disclosure is related to fuel systems using centrifugal or rotary fuel pumps, particularly to fuel systems including an electrical startup pump.

### Description of Related Art

Fuel pumps for aircraft gas turbines have generally been positive displacement types, most often gear pumps. These pumps are normally driven at a fixed ratio to engine speed. Positive displacement pumps have two major advantages over centrifugal pumps, which make them attractive for use as gas-turbine fuel pumps. First, this type of pump exhibits good dry suction characteristics, eliminating the necessity of boost pumps for priming. Secondly, positive displacement pumps provide sufficient pressure over a wide range of engine speeds. The pump sizing point typically is the flow and pressure needed for engine light-off at cranking speeds. This sizing criteria, however, results in excessive fuel delivery at higher engine speeds and altitudes, since the pump speed is tied to engine speed. This overflow requires a fuel bypass loop. Bypass and recirculation of fuel, though, results in significant fuel heating.

With the latest fuel efficient engine designs, excessive fuel heating becomes a serious problem. Reduced engine fuel consumption is accompanied by increased engine and lubrication system temperatures. With lower fuel temperatures, fuel/oil heat exchangers are capable of removing more heat from the lubrication oil, reducing the thermal load and therefore size of the air/oil heat exchangers. Associated with the air/oil heat exchangers is a significant drag and weight penalty to the aircraft.

Centrifugal pumping systems offer reduced fuel temperature rise when compared to a positive displacement pump. These pumps can simply be throttled to eliminate excess fuel delivery, so no flow bypass loop is needed. The largest heat savings is at low flows and high engine speeds, where bypass flow in a positive displacement system is at a maximum. Other advantages include increased reliability and decreased weight. Centrifugal pumps are rarely used as aircraft fuel pumps, however, because of their inability to supply adequate pressure at low speeds and their poor dry suction characteristics.

The conventional methods and systems have generally been considered satisfactory for their intended purpose. However, there is still a need in the art for fuel systems having improved reliability, specifically at low speeds. There also remains a need in the art for such fuel systems and components that are economically viable. The present disclosure may provide a solution for at least one of these remaining challenges.

### SUMMARY OF THE INVENTION

A fuel system for an engine includes a first flow line, an electrically driven startup pump in fluid communication with the first flow line to provide a startup flow, a main flow line, a main pump in fluid communication with the main flow line to provide a main flow, and a switching valve connected to the first flow line and the main flow line, the switching valve configured to select between the first flow line and the main flow line to output either the startup flow or the main flow. The fuel system further includes an electric motor configured to drive the electrically driven startup pump. The electrically driven startup pump can be a gear pump, a centrifugal pump, or a regenerative pump.

A pressure regulating valve is included in fluid communication with the electrically driving startup pump and configured for switching between a first position and a second position. The switching valve is configured to switch between a first position wherein the switching valve selects the first flow line to pass the startup flow and a second position wherein the switching valve selects the main flow line as a function of pressure differential between the main flow and the startup flow. When the startup flow is at a higher pressure than the main flow, the switching valve is biased to the first position, wherein when the startup flow is at a lower pressure than the main flow, the switching valve is biased to the second position, and the startup flow is shut down. The main pump can be a centrifugal pump, and the system can include a boost pump configured to provide a boost flow at a boost pressure to the electrically driven startup pump and the main pump by a controller configured to drive the electrically driven startup pump in a startup state of the engine. The controller can be configured to turn off the electrically driven startup pump when the switching valve transitions to or is in the second position.

A method of controlling the system at startup is also conceived. The method includes monitoring a pressure of a main pump of an engine using a controller (FADEC), supplying fuel to a start pump from a boost pump and driving an electric motor of an electrically driven pump assembly to increase pressure within the main pump, and mechanically actuating a pressure regulating valve within the electrically driven pump assembly from a first position to a second position, when a predetermined main pump pressure is reached. Once the start pump is energized, flow is produced and the pressure regulating valve (PRV) opens to bypass flow and limit the pressure to the rest of the fuel system. The valve will open and close to change system pressure/bypass flow based on fuel system demand, and when the main pump pressure is higher than start pump pressure, the switching valve will select the main pump and forcing the PRV on the start pump to open to its maximum to bypass all flow until the controller shuts down the start pump and the PRV will close as the start pump winds down. The second position of the pressure regulating valve is fully closed and can include multiple positions between fully closed and fully open.

A switching valve located downstream of the centrifugal main pump can be mechanically actuated from a first position to a second position when the pressure regulating valve actuates from the first position to the second position. Further the pressure regulating valve actuates from the first position to the second position when the electric motor shuts down. The first position is used for engine startup and engine idle and wherein the second position is used for run mode, during cruise of an aircraft.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is schematic view of a fuel system, showing during startup; and

FIG. 2 is a schematic view of FIG. 1, showing the fuel system in normal operation.

### DETAILED DESCRIPTION

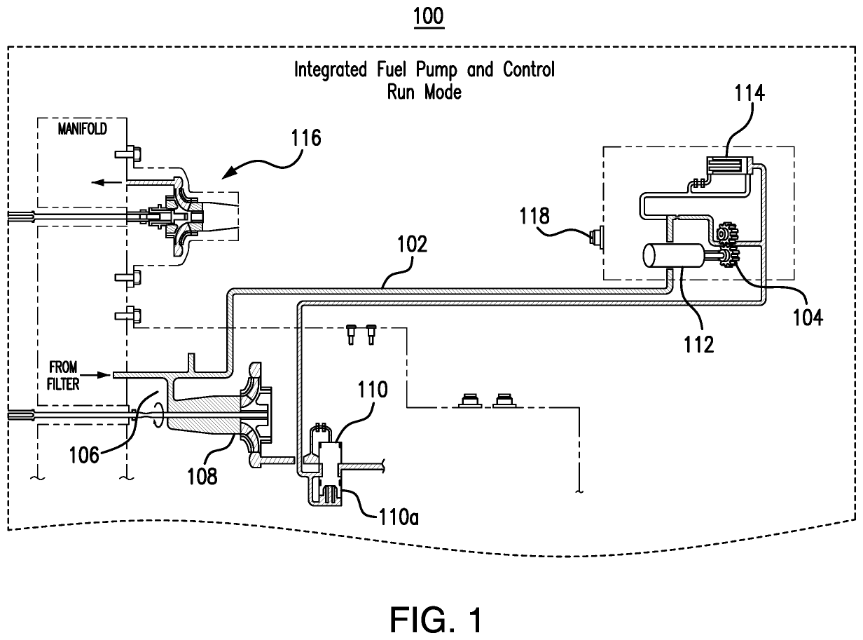

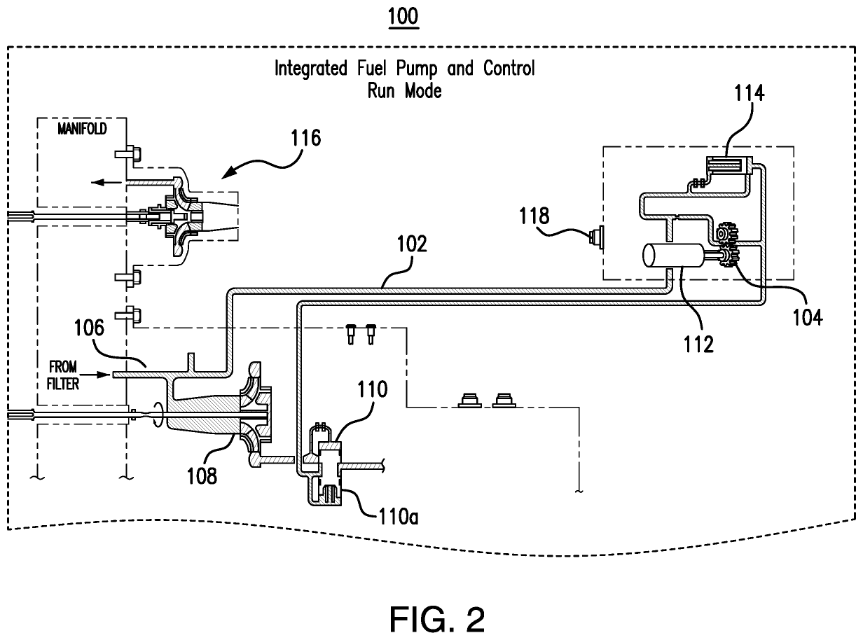

Reference will now be made to the drawings wherein like reference numerals identify similar structural features or aspects of the subject invention. For purposes of explanation and illustration, and not limitation, a partial view of an exemplary embodiment of a fuel system in accordance with the invention is shown in FIG. 1 and is designated generally by reference character 100. Other aspects of the fuel system, are provided in FIG. 2, as will be described. The methods and systems of the disclosure can be used to meet the aircraft pump needs at low and start up speeds with two pumps that overcomes the problems of the prior designs. It is a more specific object to provide an electrically driven positive displacement pump or dynamic pump with self-priming capability to be used a starting stage that supplies adequate pressure during engine start-up and up to idle speeds, as well as good dry suction characteristics.

FIG. 1 shows a fuel system 100 for an engine of an aircraft in a start-up mode. The system includes a first flow line 102, an electrically driven startup pump 104 in fluid communication with the first flow line 102. The fuel system 100 further includes a main flow line 106 and a main pump 108 in fluid communication with the main flow line 106, wherein the main flow line 106 branches off from and is in fluid communication with the first flow line 102. The main pump can be a centrifugal pump but other pumps are conceived to be capable. The fuel system further includes a switching valve 110 connected to a downstream portion of the first flow line 102, past the electrically driven startup pump and the main flow line 106, the switching valve 110 is configured to select between the first flow line 102 and the main flow line 106 to output either the startup flow or the main flow to downstream components. An electric motor 112 is connected to and configured to drive the electrically driven startup pump 104. The electrically driven startup pump 104 can be a gear pump, a centrifugal pump, or a regenerative pump. The electrically driven startup 104 allows the fuel system 100 to build pressure until such a point that the main pump 108 is able to operate. The electrically driven startup 104 allows for a smaller overall system, as the main pump 108 only has to be sized for cruise portions of the flight envelope. The fuel system also includes a pressure regulating valve 114 in fluid communication with the electrically driving startup pump 104 for switching between a first position and a second position. In the first position the pressure regulating valve 114 allows for flow to the electrically driving startup pump 104, whereas in the second position the electrically driving startup pump 104 is bypassed. The pressure regulating valve 114 allows excess flow back to the inlet of the startup pump 104. The pressure regulating valve 114 is in the open position when the start pump 104 is operating, otherwise the pressure regulating valve 114 is closed. The switching valve 110 also switches between a first position 110a wherein the switching valve 110 selects the first flow line 102 to for startup flow and a second position 110b wherein the switching valve selects the main flow line as a function of pressure differential between the main flow and the startup flow.

When the startup flow is at a higher pressure than the main flow, the switching valve 110 is biased to the first position 110a, and wherein when the startup flow is at a lower pressure than the main flow, the switching valve is biased to the second position 110b. A boost pump 116 is included to provide boost flow at a boost pressure to the electrically driven startup pump 104 and the main pump 108. The boost pump 116 is also preferred to be a centrifugal pump but other pump types are possible. A controller 118 is included to drive the electrically driven startup pump 104 and to drive both the pressure regulating valve 114 and the switching valve 110. The controller 118 is conceived to be a FADEC and is configured to turn off the electrically driven startup pump 102 when the switching valve 110 transitions to or is in the second position 110b. Each of the valves 110, 114 are purely mechanical and only change positions based on pressure. The controller 118 or FADEC is configured to control the electrically driven start pump, and a range of main pump 108 speeds. The main pump 108 is sized and configured such that a speed of the main pump 108 that triggers the electrically driven start pump 104 to shut off will be higher than a maximum speed at which the switching valve 110 moves to the closed positon 110b. The electrically driven startup pump 104 is designed to only be utilized for a few minutes to start the engine and bring the engine up to idle speeds. From there the gearbox driven centrifugal main pump 108 will take over pumping duties from the start stage and will provide fuel from idle to maximum engine speed. This stage will realize the benefits of increased fuel pressure and heat savings.

The methods and systems of the present disclosure, as described above and shown in the drawings, provide for fuel metering system with superior properties including increased reliability and reduced size, weight, complexity, and/or cost. While the apparatus and methods of the subject disclosure have been showing and described with reference to embodiments, those skilled in the art will readily appreciate that changes and/or modifications may be made thereto without departing from the spirit and score of the subject disclosure.

What is claimed is:

1. A fuel system for an engine, comprising:
a first flow line;
an electrically driven startup pump in fluid communication with the first flow line to provide a startup flow;
a main flow line;
a main pump in fluid communication with the main flow line to provide a main flow; and
a switching valve connected to the first flow line and the main flow line, the switching valve configured to select between the first flow line and the main flow line to output either the startup flow or the main flow.

2. The fuel system of claim 1, further comprising an electric motor configured to drive the electrically driven startup pump.

3. The fuel system of claim 1, wherein the electrically driven startup pump is a gear pump, a centrifugal pump, or a regenerative pump.

4. The fuel system of claim 1, further comprising a pressure regulating valve in fluid communication with the electrically driving startup pump and configured for switching between a first position and a second position.

5. The fuel system of claim 1, wherein the switching valve is configured to switch between a first position wherein the switching valve selects the first flow line to pass the startup flow and a second position wherein the switching valve selects the main flow line as a function of pressure differential between the main flow and the startup flow.

6. The fuel system of claim 1, wherein when the startup flow is at a higher pressure than the main flow, the switching valve is biased to the first position, wherein when the startup flow is at a lower pressure than the main flow, the switching valve is biased to the second position.

7. The fuel system of claim 1, wherein the main pump is a centrifugal pump.

8. The fuel system of claim 1, further comprising a boost pump configured to provide a boost flow at a boost pressure to the electrically driven startup pump and the main pump.

9. The fuel system of claim 1, further comprising a controller configured to drive the electrically driven startup pump in a startup state of the engine.

10. The fuel system of claim 9, wherein the controller is configured to turn off the electrically driven startup pump when the switching valve transitions to or is in the second position.

11. A method of engine startup control comprising:
monitoring a pressure of a main pump of an engine using a controller (FADEC);
supplying fuel to a start pump from a boost pump and driving an electric motor of an electrically driven pump assembly to increase pressure within the main pump; and
mechanically actuating a pressure regulating valve within the electrically driven pump assembly from a first position to a second position, when a predetermined main pump pressure is reached.

12. The method of claim 11, wherein the second position of the pressure regulating valve is fully closed.

13. The method of claim 11, wherein the pressure regulating valve includes multiple positions between fully closed and fully open.

14. The method of claim 11, further comprising mechanically actuating a switching valve located downstream of the centrifugal main pump from a first position to a second position when the pressure regulating valve actuates from the first position to the second position.

15. The method of claim 11, wherein the pressure regulating valve actuates from the first position to the second position when the electric motor shuts down.

16. The method of claim 11, wherein the first position is used for engine startup.

17. The method of claim 11, wherein the first position is used for engine idle.

18. The method of claim 11, wherein the second position is used for run mode.

19. The method of claim 18, wherein the run mode is during cruise of an aircraft.
